(19) United States
(12) Patent Application Publication
(10) Pub. No.: US 2023/0267353 A1
(43) Pub. Date: Aug. 24, 2023

(54) Computer-Implemented Method and System for Predicting Future Developments of a Traffic Scene

(71) Applicant: Robert Bosch GmbH, Stuttgart (DE)

(72) Inventors: Faris Janjos, Stuttgart (DE); Maxim Dolgov, Renningen (DE)

(21) Appl. No.: 18/171,080

(22) Filed: Feb. 17, 2023

(30) Foreign Application Priority Data
Feb. 21, 2022 (DE) 10 2022 201 770.6

(51) Int. Cl. G06N 7/01; G06Q 50/30

(52) U.S. Cl. CPC G06N 7/01; G06Q 50/30

(57) ABSTRACT

A computer-implemented method for predicting future developments of a traffic scene includes aggregating scene-specific information about a traffic scene, and using a pre-trained encoder network to transform the aggregated scene-specific information into parameters of a multivariate probability distribution of latent features. The method further includes selecting samples of the multivariate probability distribution of latent features determined by the parameters, and using a pre-trained decoder network to transform each of the selected samples into an output set. The samples are selected deterministically, such that each selected sample represents a separate region of the multivariate probability distribution of the latent features, and the multivariate probability distribution of latent features is sampled in a raster-like manner via the totality of the selected samples.

This application claims priority under 35 U.S.C. § 119 to patent application no. DE 10 2022 201 770.6, filed on Feb. 21, 2022 in Germany, the disclosure of which is incorporated herein by reference in its entirety.

### BACKGROUND

The invention relates to a computer-implemented method and a corresponding system for predicting future developments of a traffic scene.

The prediction of future developments of a traffic scene can be used in the context of stationary applications, such as, for example, in a permanently installed traffic control system which monitors the traffic situation in a defined spatial region. On the basis of the prediction, such a traffic control system can then provide corresponding information at an early stage and possibly also driving recommendations in order to control the traffic flow in the monitored region and in the surroundings thereof.

Another important field of application for the prediction of future developments of a traffic scene is mobile applications, such as vehicles having assistance functions. To be able to plan safe and transparent maneuvers, automated vehicles thus not only have to determine the traffic situation in which they are currently located but also to anticipate how this traffic situation will develop.

Classic prediction methods generally result in a prediction based on kinematics/dynamics. Interactions between road users can thus be modeled only to a limited extent. In addition, these approaches provide a prediction which in most cases is only useful for a very short time, for example for less than 2 s. For this reason, the use of machine learning, in particular deep learning (DL), as the de facto standard for prediction has become established in recent years.

The starting point of the present invention is a method for predicting future developments of a traffic scene, comprising the following steps:

aggregating scene-specific information about a traffic scene,

using a pre-trained encoder network to transform scene-specific information into parameters of a multivariate probability distribution of latent features,

selecting samples of the multivariate probability distribution of latent features determined by the parameters, and

using a pre-trained decoder network to transform each of the selected samples into an output set.

Methods of this type, which are based on a variational autoencoder (VAE) architecture or on an extension based on the conditional variational autoencoder (CVAE), are known. In contrast to classic autoencoder architectures, VAE and CVAE architectures also comprise a probabilistic component in addition to an encoder network and a decoder network. While the encoder network of classic autoencoders is used to transform input data in the form of aggregated scene-specific information into a set of latent features, the encoder network of a VAE/CVAE architecture transforms the input data into parameters of a multivariate probability distribution of latent features. Since however the decoder network of a VAE/CVAE architecture—as also the decoder network of a classic autoencoder—requires a set of latent features as input variables, individual samples of the multivariate probability distribution determined by the parameters are used as input variables. The decoder network then generates an output set for each of these samples.

The quality of inference is decisively determined here by how well the totality of the generated output sets approximates a probability distribution that results from the input data of the encoder network. As a rule, the quality of inference increases directly with the number of samples. This is particularly striking if the samples are selected randomly, for example using a Monte Carlo simulation. The greater the number of samples for which an output set is generated, the better the underlying probability distribution of the output sets is approximated.

This proves to be problematic in practice. In general, only a limited processing time is available for the inference, in which only a comparatively small number of samples can be processed and a corresponding number of output sets generated. As a result, the approximation of the underlying probability distribution of the output sets is inevitably suboptimal. Furthermore, with a given probability distribution of latent features and random selection of a given number of samples the inference is not reproducible, i.e., the inference yields different results when repeated. In addition, it has been shown that—depending on the nature of the prediction task—the individual samples of the probability distribution are assigned different significances. In these cases, the random selection of a limited number of samples carries the risk of the generated output sets being unspecific or in any case outputting a distorted image of the solution space of the prediction problem.

### SUMMARY

With the invention, measures are proposed by which the inference quality and thus the quality of the prediction are, using VAE/CVAE architectures, significantly increased with a manageable computational effort.

According to the invention, this is achieved by the samples being selected deterministically, such that each selected sample represents a separate region of the multivariate probability distribution of the latent features and this probability distribution is sampled in a raster-like manner via the totality of the selected samples.

The measures according to the invention make use of the continuity of neural networks. This property is a necessary condition of a raster-like sampling of the probability distribution in the space of the latent features providing a corresponding sampling of the underlying probability distribution in the space of the output sets. In this way, it can be systematically ensured that the parts of the probability distribution of the latent features that are essential for the relevant prediction task are taken into account in the inference, even if only a limited number of samples is taken into account.

It is important that the totality of the selected samples represents the probability distribution of the latent features as comprehensively as possible. This can be achieved, for example, by a uniform sampling of the probability distribution, i.e. a sampling in a uniform raster dimension, which is selected exclusively on the basis of the number of samples but independently of the probability distribution.

In one variant of the method according to the invention, the sampling is carried out not only on the basis of the number of samples, but also on the basis of the probability distribution of the latent features. In this case, the raster distances between the selected samples are thus also selected on the basis of their weight in the probability distribution. It is particularly advantageous if regions of high probability density are sampled more closely than regions of lower probability density, the raster here therefore being more finely meshed than in regions of lower probability.

Alternatively or also in addition to this deviation from a uniform raster dimension, at least a portion of the selected samples can be somewhat noisy, but the raster-like distance relationship according to the invention between the selected samples should be maintained. For this purpose, noise is superimposed on a sampling in the raster dimension (deterministic sampling), which is referred to as semi-deterministic sampling.

As already mentioned, in practice, only a limited number of samples of the probability distribution of the latent features can in most cases be used for inference. An advantage of the method according to the invention is that the number of these samples to be selected can be fixedly prespecified. In principle, in the determination of the sample number, it is always necessary to weigh up between inference time and inference quality, that is to say between the time available for the generation of output sets and the quality of how well the totality of the generated output sets approximates a probability distribution of the output sets. Advantageously, in the determination of the number and/or in the selection of the samples, it is also taken into account how similar the selected samples should be to the training data of encoder network and decoder network (ground truth) and/or how well the totality of the generated output sets provides multiple different, predetermined results (empirical significance).

VAE/CVAE architectures are usually trained such that the latent features that are extracted by the encoder network from the input data follow a multivariate standard normal distribution as probability distribution. If such a pre-trained VAR/CVAE architecture is used within the scope of the method according to the invention, the scene-specific information will preferably be transformed into an expectation-value vector and a covariance matrix, since a multivariate standard normal distribution is unambiguously determined by these parameters.

In principle, there is a wide variety of methods for sampling according to the invention the probability distribution of the latent features or for selecting the samples for the inference. In the case of a multivariate standard normal distribution, the following methods are particularly suitable, which is explained in more detail in conjunction with FIGS. 2A to 2F:

unscented Kalman filter (UKF) sampling,

Gauss-Hermite quadrature Kalman filter (GHKF) sampling,

cubature Kalman filter (CKF) sampling,

randomized unscented Kalman filter (RUKF) sampling,

asymmetric or symmetric localized cumulative distribution (LCD) sampling.

In addition, in order to implement the method described in detail above, a computer-implemented system for predicting future developments of a traffic scene is proposed, which comprises a perception plane for aggregating scene-specific information about a traffic scene, a pre-trained encoder network for transforming the scene-specific information into parameters of a multivariate probability distribution of latent features, a sampler for selecting individual samples of the multivariate probability distribution of latent features as is determined by the parameters, and a pre-trained decoder network for transforming each of the selected samples into an output set.

According to the invention, the sampler is configured to deterministically select the samples such that each selected sample represents a separate region of the multivariate probability distribution of the latent features and this probability distribution is sampled in a raster-like manner via the totality of the selected samples.

In a preferred embodiment of the system according to the invention, the encoder network and the decoder network are components of a variational autoencoder (VAE) architecture or a conditional variational autoencoder (CVAE) architecture.

### BRIEF DESCRIPTION OF THE DRAWINGS

Advantageous embodiments and developments of the invention will be explained in the following with reference to the drawings.

FIG. 1 illustrates the mode of operation of a variational autoencoder (VAE) architecture as the main component of a system according to the invention for predicting future developments of a traffic scene.

FIGS. 2A, 2B, 2C, 2D, 2E, and 2F each illustrate a different sampling approach according to the invention.

FIGS. 3A, 3B, 3C, and 3D each illustrate the mode of operation of the method according to the invention in comparison with the prior art.

### DETAILED DESCRIPTION

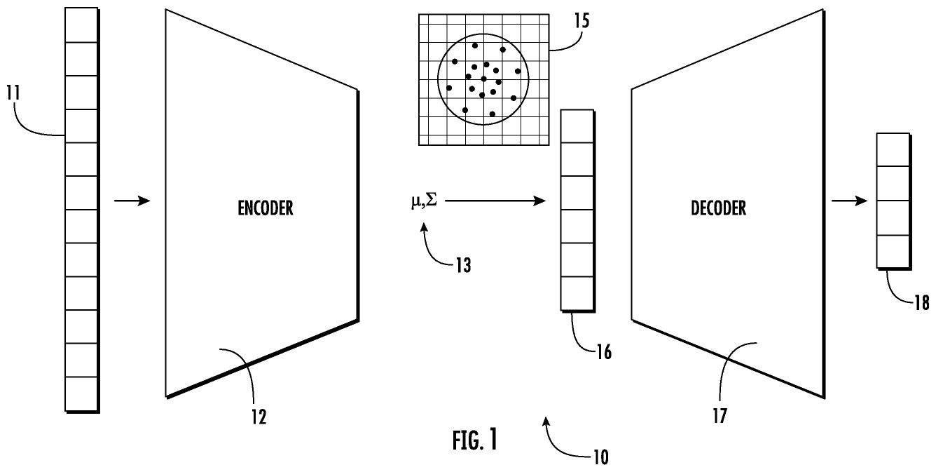

The VAE architecture 10 shown in FIG. 1 comprises an encoder network 12 for transforming input variables 11 into parameters of a multivariate probability distribution 13 of latent features. Furthermore, the VAE architecture 10 comprises a sampler 15 for selecting individual samples 16 of the multivariate probability distribution 13 of latent features determined by the parameters. Finally, the VAE architecture 10 also comprises a decoder network 17 for transforming each of the selected samples 16 into an output set 18.

The encoder network 12 and decoder network 17 are pre-trained. Two properties have been impressed on the encoder network 12 and the decoder network 17. On the one hand, the decoder network 17 delivers as output sets 18 desired or expectable results for given input variables 11 of the encoder network 12. And on the other hand, the latent features, which are extracted by the encoder network 12 from the input variables 11, follow a multivariate standard normal distribution 13.

The input variables 11 for the encoder network 12 provide a perception plane, not shown here, with which scene-specific information about a traffic scene is aggregated. Advantageously, this scene-specific information comprises semantic information about the traffic scene, in particular map information. This semantic information can be provided both locally, for example by a local storage unit, or can also be retrievable centrally, for example via a cloud. Furthermore, the scene-specific information advantageously comprises information about road users in the traffic scene. Information about the current movement state and/or the trajectory covered by the individual road users is of particular interest. Such information can be captured by sensor systems and made available, which systems, for example, comprise sensors such as video, LIDAR and radar, or also GPS (global positioning system) in conjunction with classic inertial sensors.

The aggregated scene-specific information is then transferred into a data representation that can be processed by the encoder network, which preferably also takes place in the perception plane. For example, the scene-specific information is converted into a graph representation when the encoder network is implemented in the form of a graph neural network (GNN). If the encoder network is a convolutional neural network (CNN), then the scene-specific information will be converted into a grid representation or possibly also a voxel grid representation.

The scene-specific information thus preprocessed is transformed using the encoder network 12 into parameters of a multivariate standard normal distribution 13, namely into the expectation value vector μ0 and the covariance matrix Σ of the standard normal distribution 13.

However, the decoder network 17 cannot generate output sets 18 solely on the basis of these parameters of the probability distribution 13. For this purpose, the decoder network 17 requires individual sets of latent features obtained by sampling the multivariate probability distribution 13. For the inference, it is therefore necessary to sample, specifically as far as possible, such that the output sets generated on the basis of the selected samples correspond to a distribution determined by the input variables and learned in the training method. The sampler 15 is used for this purpose. According to the invention, it selects the samples 16 deterministically or semi-deterministically, specifically in such a way that each selected sample 16 represents a separate region of the multivariate probability distribution of the latent features and this probability distribution is sampled in a raster-like manner via the totality of the selected samples. For this reason, the sampler 15 is symbolized in FIG. 1 by a sample raster of a two-dimensional probability distribution. This type of sampling has the following advantages: The number of samples is fixed at the inference time, but can be set in advance by weighing up inference time and inference quality. For example, for a given data set, the number can be selected such that a specific prediction quality is achieved. A trade-off with the duration of the inference can also take place. The number of samples can be determined in a data-based manner. It can also be taken into account here, for example, how similar selected samples and training data are, or whether the generated output sets also represent all expectable results of the prediction.

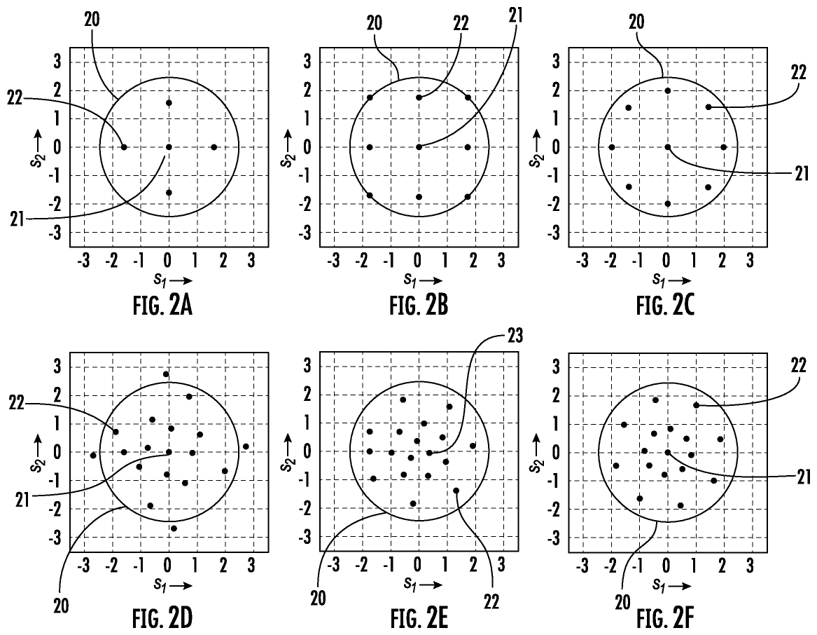

The diagrams shown in FIGS. 2A to 2F illustrate different sampling approaches using the example of a two-dimensional standard normal distribution of latent features s1 and s2. The circle 20 includes the 3-Sigma (˜99.73%) of the probability mass. The points in each case indicate the sample positions.

FIG. 2A shows the result of an unscented Kalman filter (UKF) sampling with which a total of five samples are selected. A sample 21 is positioned on the mean value of the probability distribution. The remaining four samples 22 are each arranged at the same distance from this central sample 21.

FIG. 2B shows the result of a Gauss-Hermite quadrature Kalman filter (GHKF) sampling, with which a total of nine samples are selected. A sample 21 is positioned on the mean value of the probability distribution. The remaining eight samples 22 are arranged in a square raster dimension around this central sample 21.

FIG. 2C shows the result of a cubature Kalman filter (CKF) sampling of the 5th order, with which a total of nine samples are also selected. A sample 21 is positioned on the mean value of the probability distribution. The remaining eight samples 22 are arranged evenly distributed on a circular line around this central sample 21.

FIG. 2D shows the result of a randomized unscented Kalman filter (RUKF) sampling, with which a total of 17 samples are selected. A sample 21 is positioned on the mean value of the probability distribution. Of the remaining 16 samples, in each case four are arranged uniformly distributed on concentric circular lines around this central sample 21, wherein the sample positions are offset from circular line to circular line.

FIG. 2E shows the result of an asymmetric localized cumulative distribution sampling (LCD), with which a total of 17 samples are selected. The samples 23 are positioned such that the LCD distance between the samples 23 and the probability distribution is minimized. This is achieved by solving an optimization problem. As a result, three samples 23 are here uniformly grouped around the mean value of the probability distribution. Of the other 14 samples, in each case seven are arranged uniformly distributed on concentric circular lines around these central samples 23, wherein the sample positions are offset from circular line to circular line.

FIG. 2F shows the result of symmetric localized cumulative distribution sampling (LCD), with which a total of 17 samples are selected. Here too, the samples are positioned such that the LCD distance between the samples and the probability distribution has been minimized by solving an optimization problem. For this purpose, a sample 21 was positioned on the mean value of the probability distribution. Of the remaining 16 samples, in each case eight are arranged uniformly distributed on concentric circular lines around this central sample 21, wherein the sample positions are offset from circular line to circular line.

Within the scope of the invention, the samples of the individual sampling approaches can be noisy “on a small scale”, similar to the small-signal randomization of UKF sampling in RUKF, as long as the raster-like distance relationship between the selected samples is maintained. This type of sampling is also referred to as semi-deterministic.

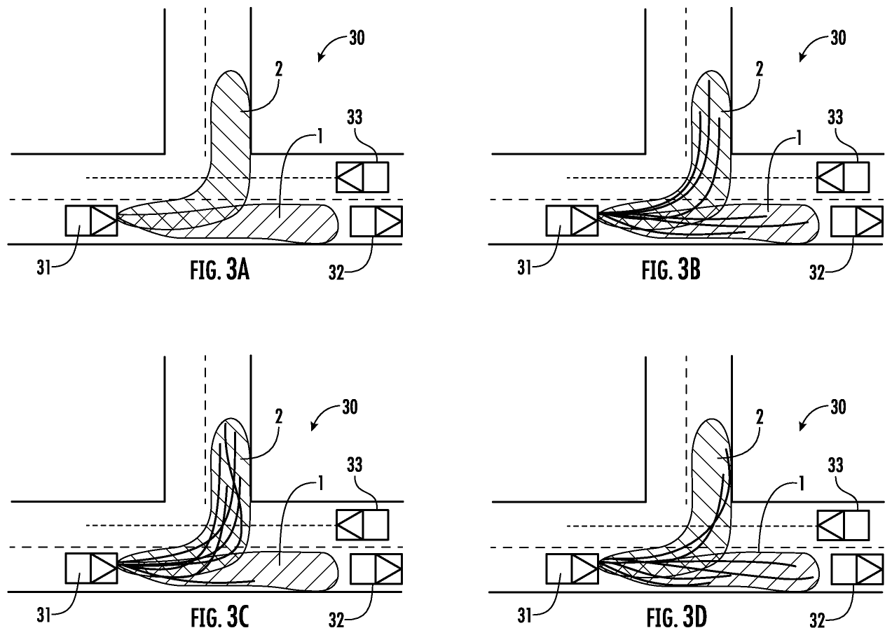

In principle, there are different possibilities for using a computer-implemented system according to the invention for predicting future developments of a traffic scene. FIGS. 3A to 3D relate to an exemplary embodiment in which possible future trajectories for a participant 31 in a traffic scene 30 are generated using the inference. In other words, for each selected sample of a probability distribution of latent features, an output set is generated in the form of a possible future trajectory for a road user 31. On the basis of the totality of the output sets or trajectories thus generated, different modes for the future development of the traffic scene are then identified.

FIGS. 3A to 3D in each case show the same traffic scene 30: a road junction which a vehicle 32 has already passed and which two vehicles 31 and 33 are approaching from different directions. Possible future trajectories of the vehicle 31 have been generated for predicting future developments of this traffic scene 30.

FIG. 3A shows the theoretically reconstructed distribution of trajectories generated with a VAE/CVAE architecture, specifically according to the prior art by means of Monte Carlo sampling, i.e., random sampling, of the probability distribution and with the number of samples approaching infinity. From this, two realistic modes can be identified, namely Mode 1 “straight ahead” and Mode 2 “turn left”.

FIG. 3B shows six predicted trajectories 35, which were also generated with a VAE/CVAE architecture, but according to the invention by means of deterministic or semi-deterministic sampling. The totality of the trajectories generated in this way is distributed uniformly between both realistic modes 1 “straight ahead” and 2 “turn left”. This shows that the quality of inference is consistent with deterministic/semi-deterministic sampling, which is not the case with random sampling and a limited number of samples. This is illustrated by FIGS. 3C and 3D.

FIGS. 3C and 3D in each case show six trajectories 35 predicted using a VAE/CVAE architecture, wherein the underlying samples were each selected by randomly sampling the probability distribution. In both cases, the six generated trajectories are not distributed uniformly between the two realistic modes 1 “straight ahead” and 2 “turn left”. In addition, the results differ. These examples illustrate that results can vary greatly when samples are randomly selected and under certain circumstances individual modes may also be completely missed. In such a case, the result will lack empirical significance.

Finally, it should also be pointed out that the invention can also be used otherwise in the context of predicting future developments of a traffic scene.

For example, probabilities for a prespecified number of different modes for the future developments of the traffic scene can also be generated as an output set in order to base the totality of the determined output sets on a further prediction step and/or planning step.

What is claimed is:

1. A computer-implemented method for predicting future developments of a traffic scene, comprising:
aggregating scene-specific information about a traffic scene;
using a pre-trained encoder network to transform the aggregated scene-specific information into parameters of a multivariate probability distribution of latent features;
selecting samples of the multivariate probability distribution of latent features determined by the parameters; and
using a pre-trained decoder network to transform each of the selected samples into an output set of a plurality of output sets,
wherein the samples are selected deterministically, such that each selected sample represents a separate region of the multivariate probability distribution of the latent features, and
wherein the multivariate probability distribution of the latent features is sampled in a raster-like manner via a totality of the selected samples to form a raster.

2. The method according to claim 1, further comprising:
adapting the raster formed by the selected samples to the multivariate probability distribution of the latent features using raster distances between the selected samples being selected based on a weight of individual selected samples in the multivariate probability distribution of the latent features.

3. The method according to claim 2, wherein:
at least a portion of the selected samples include noise, and
the raster distances between the selected samples is maintained.

4. The method according to claim 1, wherein a predetermined number of the samples are selected.

5. The method according to claim 1, wherein a determination of a number of the samples to be selected and/or the selection of the samples is based on:
a time available for generating the plurality of output sets;
a comparison of a totality of the generated plurality of output sets to a probability distribution of the plurality of output sets;
a similarity of the selected samples to training data of the pre-trained encoder network and the pre-trained decoder network; and/or
if the totality of the generated plurality of output set provides a plurality of different, predetermined results.

6. The method according to claim 1, wherein the scene-specific information is transformed into an expected value vector and a covariance matrix of a multivariate normal distribution of the latent features.

7. The method according to claim 1, wherein at least one of the following methods is used for selecting the samples:
unscented Kalman filter sampling;
Gauss-Hermite quadrature Kalman filter sampling;
cubature Kalman filter sampling;
randomized unscented Kalman filter sampling; and
asymmetric or symmetric localized cumulative distribution sampling.

8. The method according to claim 1, further comprising:
generating a possible future trajectory for at least one participant in the traffic scene as one of the output sets of the generated plurality of output sets, and
identifying different modes for a future development of the traffic scene based on a totality of the generated plurality of output sets.

9. The method according to claim 8, further comprising:
generating probabilities for a prespecified number of the different modes for the future developments of the traffic scene as one of the output sets of the generated plurality of output sets,
wherein the totality of the generated plurality of output sets is taken as a basis for a further prediction step and/or planning step.

10. A computer-implemented system for predicting future developments of a traffic scene comprising:
a perception plane configured to aggregate scene-specific information about a traffic scene;
a pre-trained encoder network configured to transform the aggregated scene-specific information into parameters of a multivariate probability distribution of latent features;
a sampler configured to select individual samples of the multivariate probability distribution of latent features determined by the parameters; and
a pre-trained decoder network configured to transform each of the selected samples into an output set,
wherein the sampler is configured to select the samples deterministically, such that each selected sample represents a separate region of the multivariate probability distribution of the latent features, and
wherein the multivariate probability distribution of latent features is sampled in a raster-like manner via a totality of the selected samples.

11. The system according to claim 10, wherein the encoder network and the decoder network are components of a variational autoencoder architecture or a conditional variational autoencoder architecture.
